(19) United States
(12) Patent Application Publication
(10) Pub. No.: US 2007/0198981 A1
(43) Pub. Date: Aug. 23, 2007

(54) SYSTEM AND METHOD FOR MULTI-PROCESSOR APPLICATION SUPPORT

(76) Inventors: Paul E. Jacobs, La Jolla, CA (US); Stephen A. Sprigg, Poway, CA (US)

Correspondence Address: QUALCOMM INCORPORATED, 5775 MOREHOUSE DR., SAN DIEGO, CA, 92121, US

(21) Appl. No.: 11/676,112

(22) Filed: Feb. 16, 2007

Related U.S. Application Data
(60) Provisional application No. 60/774,938, filed on Feb. 17, 2006.

(51) Int. Cl. G06F 9/46

(52) U.S. Cl. 718/102

(57) ABSTRACT

Described are methods and mechanisms for providing application support in a multi-processor system including receiving a request to execute an application, identifying a property specifying which processor from a plurality of processors to utilize to execute the application that is associated with the application, scheduling the application for execution on the specified processor based on the identified property, loading the application responsive to the scheduling of the application, and executing the application utilizing the specified processor.

### CROSS REFERENCE TO RELATED APPLICATIONS

This application claims priority to Provisional Application No. 60/774,938, filed Feb. 17, 2006.

### BACKGROUND OF THE INVENTION

The invention relates generally to the field of power management for computing devices, and more particularly to power management on a multi-processor mobile device.

Consumers today make use of mobile devices, such as handheld cellular telephones, to perform very many different things. Conventional mobile devices can execute various types of software applications, and often include the capability of adding or installing new software products. Each of these software products requires a different level of system power to execute based, in part, on the amount of computation requirements the software product places on the processor that executes it. For instance, native user interface (“UI”) applications often require much less computational effort than do multi-media applications or high-speed games.

Some mobile devices attempt to address this issue by using a two-processor design that includes a low-power processor and a high-power processor. Using this design, functions of the mobile device are segregated so that certain functions always use the low-power processor (e.g., code to operate the modem) and other functions always use the high-power processor (e.g., any installed applications). While this design ensures a high level of performance for the user, it also results in shorter battery life because the high-power processor is powered on to handle applications regardless of the level of computational effort needed.

An adequate system for supporting a multi-processor platform in a mobile device has eluded those skilled in the art, until now.

### SUMMARY OF THE INVENTION

The invention is directed to a system and method for executing an application in a multi-processor system. Briefly stated, a multi-processor (e.g., dual processor) application specific integrated circuit (“ASIC”) is provided that includes at least a low-power processor and a high-power processor. The ASIC is controlled by an operating system that is configured to support the execution of applications. When an application is loaded, the operating system evaluates a property associated with the application to determine on which of the multi-processors to execute the application. The application is then scheduled to execute on the appropriate processor.

In one aspect, a method for executing an application in a multi-processor system includes receiving a request to execute an application and identifying a property associated with the application. The property specifies which processor from a plurality of processors to utilize to execute the application. The method further includes scheduling the application for execution on the specified processor based on the identified property. The method additionally includes executing the application on the specified processor.

In another aspect, a mobile device includes a first processor, a second processor, at least one memory storage device in communication with the processors, and at least one computer-readable memory device which is readable by the processors. The computer-readable memory includes a series of computer-executable steps configured to cause the processors to receive a request at an operating system to execute an application; identify a property associated with the application, the property specifying which processor from a plurality of processors to utilize to execute the application; schedule the application for execution on the specified processor based on the identified property; and execute the application utilizing the specified processor.

In yet another aspect, a computer readable medium storing a computer program for executing an application in a multi-processor system includes computer-readable code to receive a request to execute an application; computer-readable code to identify a property associated with the application, the property specifying which processor from a plurality of processors to utilize to execute the application; computer-readable code to schedule the application for execution on the specified processor based on the identified property; and computer-readable code to cause the application to be executed using the specified processor.

In another aspect, a system for executing an application in a multi-processor system includes means for receiving a request to execute an application; means for identifying a property associated with the application, the property specifying which processor from a plurality of processors to utilize to execute the application; means for scheduling the application for execution on the specified processor based on the identified property; and means for executing the application utilizing the specified processor.

In another aspect, a method for processing an application in a multi-processor environment includes receiving a request to process an application, identifying a property associated with the application, the property specifying which processor from a plurality of processors to utilize to process the application and processing the application. In one aspect, the application may be content data.

In another aspect, a mobile device includes a first processor, a second processor, at least one memory storage device in communication with the processors, and at least one computer-readable memory device which is readable by the processors. The computer-readable memory includes a series of computer-executable steps configured to cause the processors to receive a request at an operating system to process an application; identify a property associated with the application, the property specifying which processor from a plurality of processors to utilize to process the application; and process the application utilizing the specified processor. In one embodiment, the application may be content data.

### BRIEF DESCRIPTION OF THE DRAWINGS

FIG. 1 is a functional block diagram generally illustrating a mobile device in which implementations of the invention are particularly applicable.

FIG. 2 is a functional block diagram generally illustrating a system for providing multi-processor application support in accordance with an embodiment of the invention.

FIG. 3 is a conceptual illustration of an operating system providing multi-processor application support in accordance with an embodiment of the invention.

FIG. 4 is an operational flow diagram generally illustrating a process for providing multi-processor application support.

### DETAILED DESCRIPTION

What follows is a detailed description of various techniques and mechanisms for power management in a mobile device. Very generally stated, the present invention is directed to determining which of a plurality of processors on which to execute an application based on a property of the application. Note that throughout this description, the term “application” is used for convenience and not intended to be limiting. For example, it will be recognized by those skilled in the art that “application” as used herein includes any function, task, content or other data sent to a processor for processing.

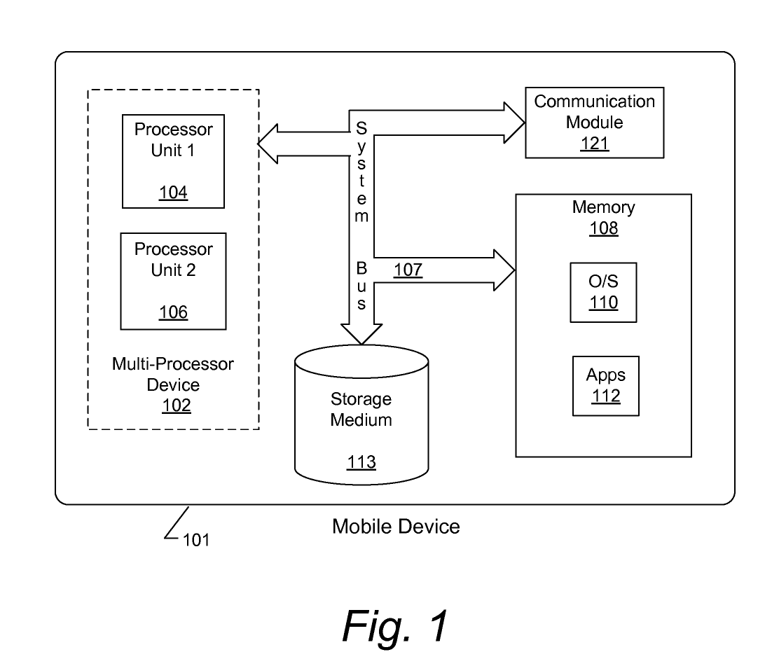

FIG. 1 is a functional block diagram generally illustrating a sample mobile device 101 in which implementations of the invention are particularly applicable. The mobile device 101 may be any handheld computing device, such as a cellular telephone, a personal digital assistant, a portable music player, a global positioning satellite (GPS) device, and the like. Although described here in the context of a handheld computing device, it should be appreciated that implementations of the invention may have equal applicability in other areas, such as laptop, desktop, or perhaps even server computing devices.

In this example, the mobile device 101 includes a multi-processor device 102, a memory 108, a storage medium 113, and a communication module 121 all coupled over a system bus 107. The multi-processor device 102 may be an Application Specific Integrated Circuit (“ASIC”) that includes a first processor unit 104 and a second processor unit 106 encapsulated into a single unit. In another embodiment (not shown) each processor is implemented as a discrete unit.

In accordance with one embodiment of the present invention, one processor unit (e.g., processor unit 1 104) is more powerful than the other processor unit (e.g., processor unit 2 106). The more powerful processor is selected when more processing throughput is desired, such as may be more suitable for applications that are processor intensive. However, the less powerful processor consumes less power, and therefore results in more generous battery life and may be more acceptable for less process intensive applications (including tasks). Each of the processor units (processor unit 104 and 106) is a microprocessor or a special-purpose processor such as a digital signal processor (DSP), but may in the alternative be any conventional form of processor, controller, microcontroller, or state machine. In one example, the first processor unit 104 is implemented as a high-power microprocessor, and the second processor unit 106 is implemented as low-power DSP. Mobile device 101 may also include additional components known to those skilled in the art.

Multi-processor device 102 is coupled to the memory 108, which may be implemented as RAM holding software instructions that are executed by the processor units 104 and 106. In this embodiment, the software instructions stored in the memory 108 include one or more applications 112 and an operating system 110. It is important to note that the memory 108 could be implemented as standalone RAM, or it could be integrated into the multi-processor device 102 with the processor units 104 and 106 to achieve improved efficiencies. The memory 108 may be composed of firmware or flash memory, such as a SmartMedia card. In another embodiment, operating system 110 includes software instructions enabling operating system 110 to determine which processor unit to use for execution of one or more applications from applications 112.

The storage medium 113 may be implemented as any nonvolatile memory, such as ROM memory, flash memory, or a magnetic disk drive, just to name a few. The storage medium 113 may also be implemented as any combination of those or other technologies, such as a magnetic disk drive with cache (RAM) memory, or the like. In this particular embodiment, the storage medium 113 is used to store data during periods when the mobile device 101 may be powered off or without power.

The communication module 121 enables bidirectional communication between the mobile device 101 and one or more other computing devices. Communications module 121 may include components to enable RF or other wireless communications, such as a cellular telephone network, Bluetooth connection, wireless local area network, or perhaps a wireless wide area network. Alternatively, communications module 121 may include components to enable land line or hard wired network communications, such as an Ethernet connection, universal serial bus connection, IEEE 1394 (Firewire) connection, or the like. These are intended as non-exhaustive lists and many other alternatives are possible.

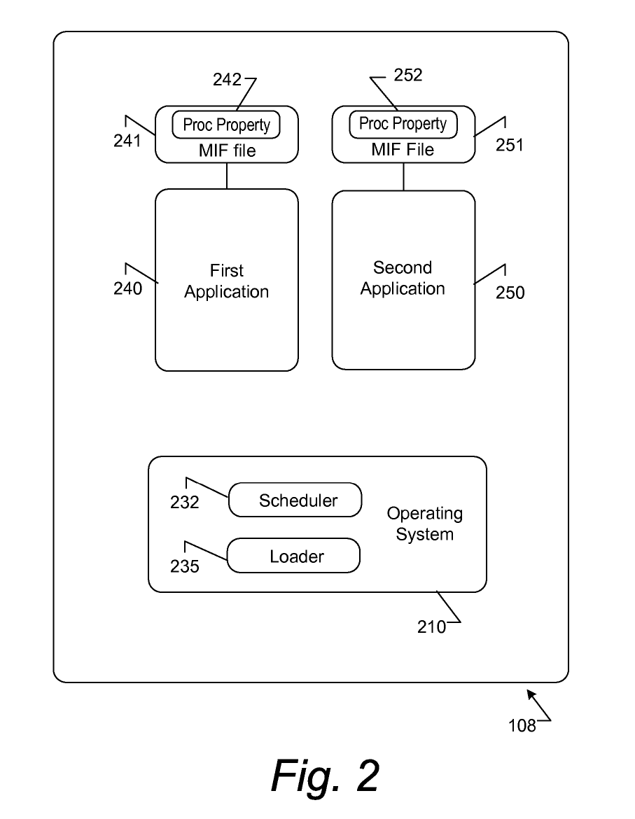

FIG. 2 is a functional block diagram illustrating in slightly greater detail the system memory 108 in which implementations of the invention are particularly applicable. As mentioned above, the system memory 108 includes an operating system 210 and one or more applications, such as first application 240 and second application 250. Each of those components will be described here in the context of the invention.

To illustrate the principles of the invention, the first application 240 requires greater processing power to perform acceptably, such as a multi-media application or a high-speed game. The second application 250 requires less processing power to perform acceptably, such as a native user interface module or the like. Each of the applications also has associated meta information such as a module information file (a “MIF” file), which includes salient details about the application such as its icon, title, and an enumeration of the privileges it requires in order to operate. Accordingly, the first application 240 as an associated MIF file 241, and the second application 250 has an associated MIF file 251.

Each respective MIF file further includes an identifier or property that either directly identifies on which of plural processors to execute the application, or includes identifying information that can be used to determine on which processor to execute the application (the “proc property”). For example, the first application 240 has a MIF file 241 including a proc property 242 that indicates the first application 240 requires greater processing power. Similarly the second application 250 has a MIF file 251 including a proc property 252 that indicates the second application requires less processing power and may function adequately on a low power processor. It should be noted that the actual form of the data in the property can take many forms. For example, it is envisioned that classes of processors may develop that generally categorize processors by their computational performance, by power consumption, or both. In this manner, the proc property may simply identify a minimum required processor rather than directly identifying a specific processor on which to execute the application.

The operating system (O/S) 210 is configured to organize and control the hardware and software of the mobile device. In this particular embodiment, the operating system 210 includes a scheduler 232 and a loader 235. The scheduler 232 manages the processes that may be executing on the mobile device, and schedules processor time for each process or thread. In addition, the scheduler 232 is configured to determine which processor on which to execute a particular application by referring to the proc property of the application. To that end, the scheduler 232 is configured to read, directly or indirectly, meta information from the MIF file associated with the application to determine which processor on which to execute the application. The loader 235 is configured to load an application into a process and begin executing the application on a particular processor under control of the scheduler 232. In one embodiment, the scheduler 232 and the loader 235 operate in a kernel mode or protected mode of execution.

In operation, operating system 210 receives an instruction to execute the first application 240, such as via a system call from a shell. This instruction may have been initiated by a user selecting and activating an icon in a user interface, or the like. In this particular implementation, the operating system 210 then queries the local storage device to determine the location of the application 240. The operating system 210 reads the MIF file 241 for the application 240 to identify the execution environment for the application 240, such as which processor to be used in a multi-processor environment when executing the associated application. The operating system 210 may extract the proc property 242 from the MIF file 241 and pass it to the scheduler 232, along with an instruction to execute the application 240.

The scheduler then schedules the application to be loaded in the system memory 180 and executed on a particular processor, in accordance with the proc property of the application. The loader then loads the application into the identified memory locations. The ability of the scheduler 232 and operating system 210 to match an application with a processor increases overall system power utilization efficiency.

In other embodiments, when scheduler 232 reads properties (e.g. properties 242 and 252) from applications (e.g. first application 240 and second application 250, respectively), scheduler 232 may not match an application to a processor. For example, in a single processor configuration the scheduler 232 could simply ignore the proc property, and schedule the execution of the application in the conventional manner. Similarly, in a multi-processor configuration when the processor identified by the property is unavailable, scheduler 232 schedules the application based on other criterion, such as the most efficient use of the system processors. In yet another example, in a multi-processor configuration when an application does not identify a preferred processor, the scheduler 232 could schedule the application in the conventional manner, such as the most efficient use of the system processors.

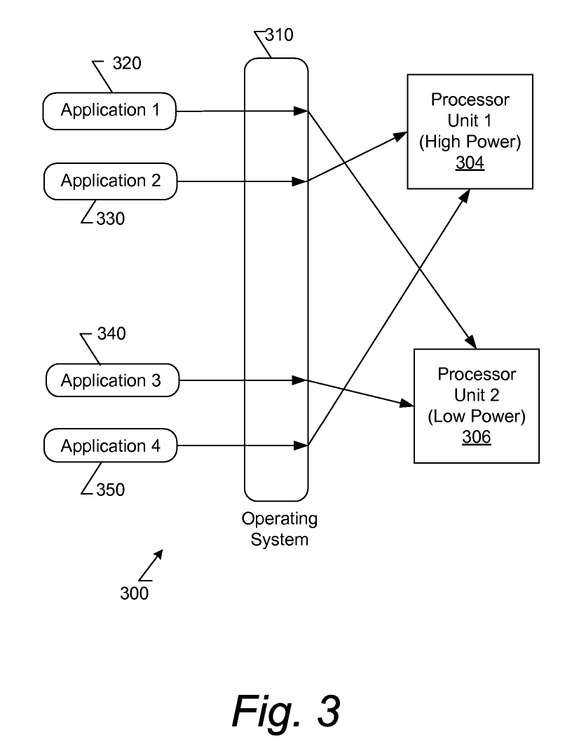

FIG. 3 is a graphical illustration of an operating system 310 scheduling the execution of each of four applications on each of two processors based on a property of the applications, in accordance with the invention. The exemplary application loading system 300 shown in FIG. 3 may be implemented on mobile device 101, described above. Application loading system 300 is used to increase the overall efficiency of a computing system within which application loading system 300 operates. It does so by identifying and reading a property (described in FIG. 2, above) associated with the application that instructs the operating system 310 to execute the application on a specified processor.

In FIG. 3, application loading system 300 includes first processor 304, second processor 306, operating system 310, first application 320, second application 330, third application 340, and fourth application 350. The first processor 304, which may be a processor core on an ASIC, is a relatively-high performance and power processing unit. In contrast, the second processor 306, which may be another processor on the same ASIC as the first processor 304, is a relatively-low performance processing unit that consumes less power than the first processor 304.

In this example, first application 320 is a native user interface (U/I) application, second application 330 is a multi-media application such as for viewing .mpeg files or playing .wav files, third application 340 is a native cellular transmission and/or reception application, and fourth application 350 is a high-speed entertainment application such as a game. Accordingly, it has been determined in advance that the first application 320 and the third application 340 will achieve acceptable levels of performance using a lower power processor. In contrast, it has also been determined that the second application 330 and the fourth application 350 require a higher power processor to achieve acceptable performance levels. Thus, the first application 320 and the third application 340 both include a property that identifies the second processor 306 as the preferred processor on which to execute those applications. Similarly, the second application 330 and the fourth application 350 both include a property that identifies the first processor 304 as the preferred processor one which to execute those applications.

In addition, if the processor specified by the property within an application is unavailable, the operating system 310 schedules the execution of the application based on other criterion. For example, to achieve adequate performance during a period when the low power processor is being highly utilized, the operating system 310 may schedule an otherwise low-power application to execute on the higher-power processor. Moreover, when the processor is not specified by the property within an application, operating system 310 may schedule the application based on other criterion, such as conventional load balancing or power considerations.

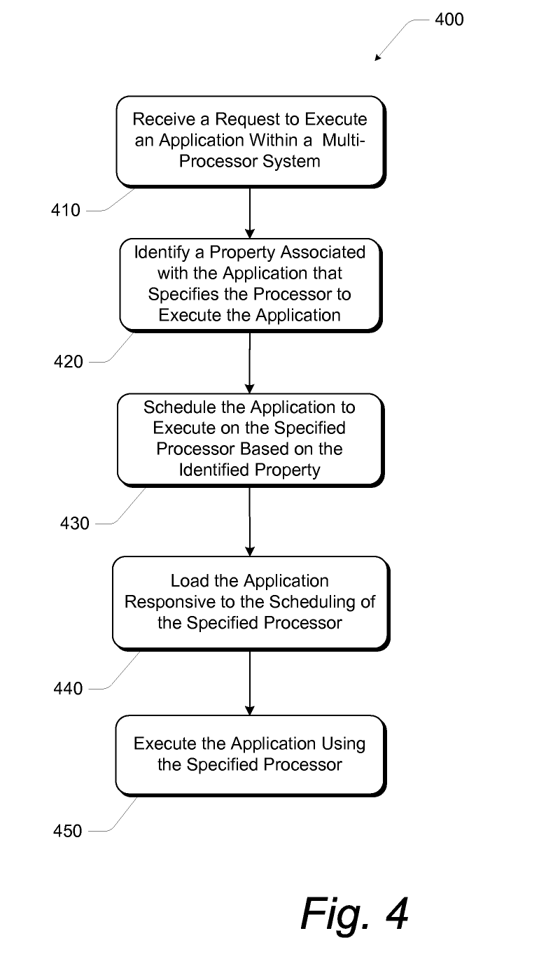

FIG. 4 is an operational flow diagram generally illustrating a method 400 for providing support for an application to direct on which processor in a multi-processor system to execute. In one embodiment, method 400 is implemented with components of the exemplary operating environments of FIGS. 1-3. Preferably, one or more steps of method 400 are embodied in a computer readable medium containing computer readable code such that a series of steps are implemented when the computer readable code is executed on a computing device. In some implementations, certain steps of method 400 are combined, performed simultaneously or in a different order, without deviating from the objective of method 400.

At step 410, a request for execution of an application within a multi-processor system is received at an operating system. In one embodiment, the operating system receives an instruction to execute an application, such as via a system call from the shell. In an example and referring to FIG. 1 above, operating system 110 receives an instruction to execute an application within applications 112, such as a system call from the shell via media control component 111.

At step 420, a property associated with the application is identified. The property provides information that is used to determine on which processor within the multi-processor system to execute the application. In one embodiment, a property associated with the application is identified by a component of the operating system. In an example and referring to FIG. 2 above, operating system 210 identifies first proc property 242 associated with first application 240 and passes the contents of the identified property to scheduler 232.

At step 430, the application is scheduled for execution on the specified processor based on the identified property. In one embodiment, the scheduler determines whether the identified processor is currently operating at an acceptable utilization to support the execution of the application. In an example and referring to FIGS. 1 and 2 above, scheduler 232 (within operating system 210 and 110) creates a process in which to execute the application 240, and then schedules that process for execution on the first processor 104.

At step 440, the application is loaded responsive to the scheduling of the application. In one embodiment, the loader loads the application into memory responsive to the scheduler scheduling the application to be loaded. In an example and referring to FIG. 1 and 2 above, loader 235 loads application 240 into memory 108 responsive to scheduler 232 scheduling application 240 to be loaded.

At step 450, the application is executed using the specified processor. In one embodiment, the scheduler sets the stack pointer of the processor that was previously identified to the memory location containing portions of the application.

Advantageously, the system and techniques described above enable a mobile device having two processor cores on a single ASIC, where one processor core has a lower power consumption requirement than the other processor core, and where both processor cores share resources, such as RAM and operating system components. In addition, applications installed on the mobile device may be scheduled for execution on the processor that would result in an appropriate power and performance balance, rather than on a hard rule governing which applications run on which processors. These system and techniques result in improved battery life without necessarily sacrificing application usability.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

We/I Claim:

1. A method for executing an application in a multi-processor system, comprising:
receiving a request to execute the application;
identifying a property associated with the application, the property specifying which processor from a plurality of processors to utilize to execute the application;
scheduling the application for execution on the specified processor based on the identified property; and
executing the application utilizing the specified processor.

2. The method of claim 1, wherein the plurality of processors include a higher throughput processor and a lower throughput processor.

3. The method of claim 2, further comprising the step of assigning the property associated with an application based on the application's throughput processing need.

4. A method for processing an application in a multi-processor system, comprising:
receiving a request to process the application;
identifying a property associated with the application, the property specifying which processor from a plurality of processors to utilize to process the application; and,
processing the application utilizing the specified processor.

5. The method of claim 4, wherein the plurality of processors include a higher throughput processor and a lower throughput processor.

6. The method of claim 4, wherein the application is content data.

7. A mobile device comprising:
a communication bus;
a first processor;
a second processor;
at least one memory storage device in communication with the processors; and
at least one computer readable memory device which is readable by the processors, the computer readable memory device including a series of computer-executable steps configured to cause the processors to:
receive a request at an operating system to execute an application;
identify a property associated with the application, the property identifying which processor from a plurality of processors on which to execute the application;
schedule the application for execution on the specified processor based on the identified property; and
execute the application on the specified processor.

8. A mobile device comprising:
a communication bus;
a first processor;
a second processor;
at least one memory storage device in communication with the processors; and
at least one computer readable memory device which is readable by the processors, the computer readable memory device including a series of computer-executable steps configured to cause the processors to:
receive a request at an operating system to process an application;
identify a property associated with the application, the property identifying which processor from a plurality of processors on which to process the application; and
process the application on the specified processor.

9. The mobile device of claim 8, wherein the first processor has a different processing throughput than the second processor.

10. The mobile device of claim 8, wherein the application is content data.

11. A computer readable medium storing a computer program to execute an application in a multi-processor system, comprising:
computer readable code to receive a request to execute the application;
computer readable code to identify a property associated with the application, the property specifying which processor from a plurality of processors to use to execute the application;
computer readable code to schedule the application for execution on the specified processor based on the identified property;
computer readable code to load the application responsive to the scheduling of the application; and
computer readable code to execute the application utilizing the specified processor responsive to the loading of the application.

12. A computer readable medium storing a computer program to process an application in a multi-processor system, comprising:
computer readable code to receive a request to process the application;
computer readable code to identify a property associated with the application, the property specifying which processor from a plurality of processors to use to execute the application;
computer readable code to schedule the application for processing on the specified processor based on the identified property.

13. The computer readable medium of claim 12, wherein the application is content data.

14. A device for executing an application in a multi-processor system, comprising:
means for receiving a request to execute the application;
means for identifying a property associated with the application, the property specifying which processor from a plurality of processors to utilize to execute the application;
means for scheduling the application for execution on the specified processor based on the identified property; and
means for executing the application on the specified processor.

15. A device for processing an application in a multi-processor system, comprising:
means for receiving a request to process the application;
means for identifying a property associated with the application, the property specifying which processor from a plurality of processors to utilize to execute the application;
means for processing the application on the specified processor.

16. The device of claim 15, wherein the application is content data.
